(19) United States
(12) Patent Application Publication
(10) Pub. No.: US 2014/0119560 A1
(43) Pub. Date: May 1, 2014

(54) Jam Jack

(71) Applicants: David Thomas Stewart, Tijeras, NM (US); David Alfred Jarrett, Albuquerque, NM (US)

(72) Inventors: David Thomas Stewart, Tijeras, NM (US); David Alfred Jarrett, Albuquerque, NM (US)

(21) Appl. No.: 13/664,047

(22) Filed: Oct. 30, 2012

(51) Int. Cl. H04R 3/00

(52) U.S. Cl. CPC H04R 3/00
USPC 381/77

(57) ABSTRACT

This invention explains the use of a device that uses either WiFi or BLUETOOTH technologies to interface to musical equipment. The use of these technologies eliminates the need to use cables to transmit the signals from instrument to interface and also allows for easy collaboration and sharing of music, musical ideas and the like.

### BACKGROUND OF THE INVENTION

1. Field of the Invention

This invention explains the use of a device that uses either WiFi or BLUETOOTH technologies to interface to musical equipment.

2. Description of Prior Art

U.S. Pat. No. 7,818,078 The present invention is directed to wireless analog audio systems for transmission and reception of a signal from an electric analog audio signal-generating device to an electric analog audio signal-receiving device. One example of such a signal-generating device is an electric guitar. By using a transceiver, the guitar is adapted to generate analog audio signals, convert those signals into digital signals, format the digital signals according to a digital communication protocol, and to output the formatted signals. The guitar may include a novel multi-signal guitar pickup that generates some of the analog audio signals. The interface device of the present invention is adapted to wirelessly and in real time receive digital signals, convert those signals into analog signals representing what is being played at the guitar, and output the analog signals to a standard guitar amplifier. Moreover, the system presented here does not require any modification of standard guitar equipment.

This patent offers no ability to record or share the musical ideas or composition directly from the instrument, to a WiFi or BLUETOOTH capable device. Then allowing the musical ideas or composition to be shared, using social media like e-mail, Twitter or Facebook.

### SUMMARY OF THE INVENTION

The Jam Jack takes the signal being produced by a musical instrument and sends it over an interface capable of receiving BLUETOOTH or WiFi. This will allow the musician to immediately record, analyze or share their work. For instance, two musicians can be communicating ideas over social media instantaneously using, but not limited to, a smart phone or tablet.

It is therefore a primary object of this invention to provide a simple, convenient yet powerful way to capture and share musical ideas and compositions either in real-time or by allowing the user to save their work for future sharing, editing or otherwise distributing via social media.

It is another object of the present invention to allow instantaneous transfer of musical parts and ideas to be used in a recording or production of other musical media such as, but not limited to, a typically recording studio setup. Such a setup normally consisting of several of the interfaces connected to both instruments and voices and being transmitted via BLUETOOTH or WiFi to a smart-phone, tablet or computer running an audio mixing application or other suitable audio related application.

It is a further object of the present invention that it will provide a wireless interface to a signal processing application(s) installed on BLUETOOTH and WiFi capable devices, allowing for, but not limited to, distortion boxes and voice boxes.

### BRIEF DESCRIPTION OF THE DRAWINGS

FIG. 1 “Plan View” shows the construction and physical form of the device.

FIG. 1 Item descriptor #1—Inner Housing.

FIG. 1 Item descriptor #2—PCB outer cover.

FIG. 1 Item descriptor #3—Battery compartment outer cover.

FIG. 1 Item descriptor #4—2 AA batteries.

FIG. 1 Item descriptor #5—Printed Circuit Board (PCB).

FIG. 1 Item descriptor #6—Antenna.

FIG. 1 Item descriptor #7—¼″ Plug.

### DETAILED DESCRIPTION OF THE INVENTION

### Definitions

Power is supplied to the device. The musical signal is received form the instrument via a standard ¼′ jack to an analog to digital receiver on the device. The main processor then conditions the newly digitized signal for the BLUETOOTH or WiFi transceiver, depending on the application. The conditioned signal is then broadcast for reception to a BLUETOOTH or WiFi capable device.

### Best Mode of the Invention

FIG. 2 shows the intended use of the device. This depicts the device plugged in and transmitting the musical signal.

### How to Make the Invention

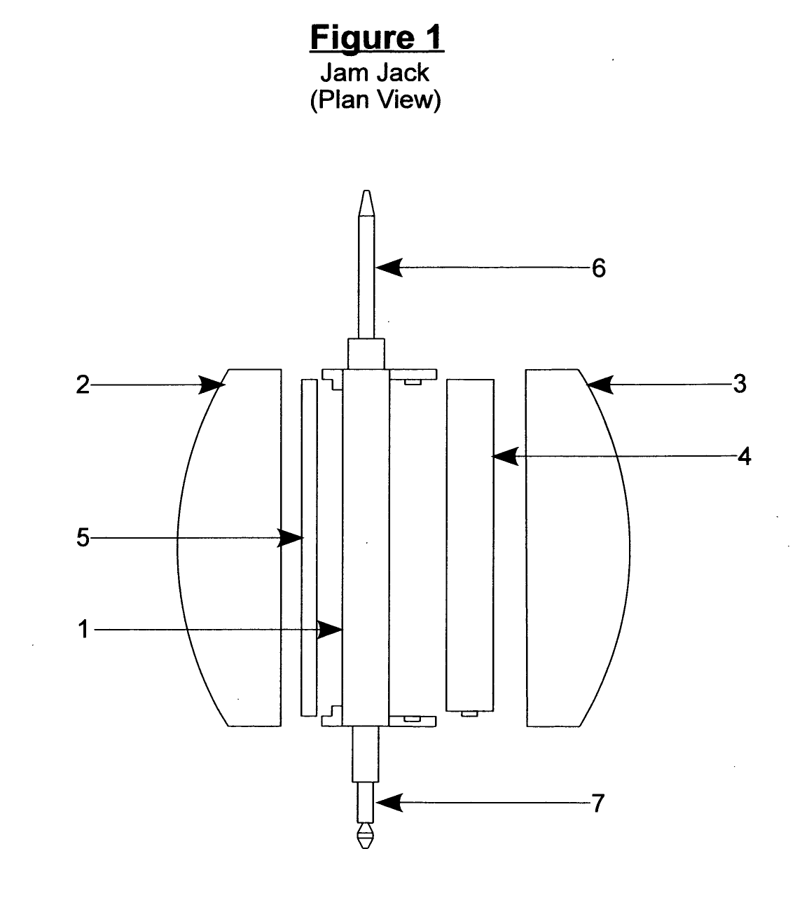

The printed circuit board containing the Gumstix processor, analog to digital converter and the BLUETOOTH or WiFi module is encapsulated in the housing as shown in FIG. 1. There are three switches: on/off, wireless mode and select. The on/off switch is a slider-type switch wired to the pcb as shown. The wireless mode entry switch is also a slide switch and is wired to the pcb as shown. The entry switch is a pushbutton type switch. All three switches are then placed in the housing. There is one LED. The LED is wired to the pcb and placed in the housing. A quarter inch plug is wired to the pcd and placed in the housing. This part of the housing is now joined together as shown FIG. 1. The batteries are placed in the rear of the device.

### How to Use the Invention

Install suitable batteries. The device is plugged into the selected instrument or other suitable audio source. Slide the wireless mode switch to either the BLUETOOTH setting or the WiFi setting, as desired. Switch the power switch from the OFF to the ON position. At this time the device will, if it has been previously configured, connect via the selected wireless type and begin transmitting the digitized audio.

If the wireless connection type had not been previously configured, then the connection must be initialized. For BLUETOOTH, the device must go through the standard discovery and pairing. The BLUETOOTH receiving device, such as a smart phone or tablet, will have the ability to do the pairing via the standard pairing procedure, which may vary slightly from receiver to receiver. The device, when un-paired, will advertise itself as the “Stewart Jam Jack 001”. Once paired, no further action is required. To un-pair from a BLUETOOTH device, the wireless mode switch must be set to BLUETOOTH and the device must be on. Then the entry switch must be pressed and held for 5 seconds. At this time, the LED will blink 5 times and the device will have become un-paired and ready to pair with another Bluetooth enabled device.

WiFi settings are standard IPv4 of the type X.X.X.X. For the initial setup of the device, the device assumes a network address of 10.0.1.200. It will begin broadcasting to well-known port 1920. A setup application, running on a PC can be used to connect to the device. Once connected, any IP address and port can be chosen to be compatible with the user's wireless network. As with the BLUETOOTH mode, the device may be returned to its default values (10.0.1.200:1920) by leaving the wireless mode switch in the Wifi setting and holding the entry switch down for 5 seconds.

If the battery is becoming low, the LED will start flashing two quick flashes, alerting the user that the battery must be changed. Batter level may be checked by one quick push to the entry button. The LED will then flash between 1 and 10 times. 10 times indicates a completely charged battery, one time indicates that the battery should be changed.

What is claimed is:

1. A wireless interconnect comprising: a device that is capable of taking a musical instrument-type signal and transmitting over BLUTOOTH or WiFi to any Blutooth or WiFi capable device to capture the signal for the data to be shared with others over various wireless systems.

2. A wireless interconnect according to claim 1, wherein said device is used for a stringed instrument either electric or equipped with a pick up or microphone.

3. A wireless interconnect according to claim 1, wherein said device is used for an electronic instruments that would include but not limited to electric drums, piano and synthesizers.

4. A wireless interconnect according to claim 1, wherein said device is used for stand alone microphone.

5. A wireless interconnect according to claim 1, wherein said device is used for computer generated music.

6. A wireless interconnect according to claim 1, wherein said device is used for communicating with a BLUTOOTH or WiFi compatible device. Said devices would be using applications used for processing the musical signal.

7. A wireless interconnect according to claim 1, wherein said device is used for communicating with a BLUTOOTH or WiFi compatible speaker or headphone.

8. A wireless interconnect according to claim 1, wherein said device is used for communicating with another a BLUTOOTH or WiFi compatible device.

9. Custom software according to claim 1, comprising: a high-speed analog to digital converter routine sampling to convert an audio frequency range of 20 Hz to 10 KHz, and output the samples to either a BLUETOOTH or Wifi wireless connection allowing audio to be used by any of a wide variety of interfacing equipment for real-time processing and sharing via social media or other means.

10. Custom software according to claim 1, comprising: the means to allow a user to dynamically download audio filters that may process the incoming sampled audio stream thus providing various audio effects typically used to modify the sound of an instrument or other sampled audio source.
